(19) United States
(12) Patent Application Publication
(10) Pub. No.: US 2019/0318318 A1
(43) Pub. Date: Oct. 17, 2019

(54) Virtual Staffing Assistant

(71) Applicant: PRO Unlimited Global Solutions, Inc., Boca Raton, FL (US)

(72) Inventors: Ted Sergott, Moraga, CA (US); Nataliya Kolb, San Francisco, CA (US); Drew Wittig, San Francisco, CA (US); Dustin Burgess, Folsom, CA (US)

(21) Appl. No.: 16/382,119

(22) Filed: Apr. 11, 2019

Related U.S. Application Data
(60) Provisional application No. 62/656,883, filed on Apr. 12, 2018.

(51) Int. Cl. G06Q 10/10; H04L 12/18

(52) U.S. Cl. CPC G06Q 10/1053; H04L 12/1813; G06Q 10/1091

(57) ABSTRACT

The present invention is directed to systems and methods for providing a virtually assisted staffing platform providing recruitment services, recruitment-related services, and the like. In particular, this invention relates to systems and methods for providing a virtual assistant leveraging machine learning to provide mobile-based and web-based information in real-time. The present invention comprises a virtual assistant that tracks and recommends alternative employer locations, extraneous skills, and recommends candidates to staffing suppliers.

### RELATED APPLICATIONS

This application claims priority from the United States provisional application with Ser. No. 62/656,883, which was filed on Apr. 12, 2018. The disclosure of that provisional application is incorporated herein as if set out in full.

### FIELD OF THE INVENTION

The present invention is directed to systems and methods for providing recruitment services and recruitment-related services as they may relate to suppliers, hiring managers and hiring entities in a network environment. In particular, this invention relates to systems and methods for providing data-driven, client-specific, embedded intelligence to a user in real time.

### BACKGROUND

A wide variety of human resources personnel may be involved in the hiring process in the modern era. While large companies have human resources departments that are responsible for managing hiring of new employees, smaller businesses may subcontract the HR work to outside recruiting firms or may delegate the staffing responsibilities to higher level executives or managers. In either case, the hiring process may be costly and time consuming due to the relatively high wages paid to personnel with human resource training.

Thus, freelance recruiters in the modern era are often inundated with work, including files covering hundreds of candidates applying for positions in a diversity of fields. Particularly in times of economic stress where very large numbers of candidates may be seeking a small number of openings, the review process can tax even the most experienced staffing supplier. As a consequence, the demand for low-cost and efficient automated means of matching suitable candidates with job openings has grown.

Even with the assistance of software systems, the challenge of matching suitable candidates with job openings remains substantial. During the screening process, for example, qualified candidates may be erroneously removed from an initial pool of candidates due to human error. While hiring managers often intend to remove many candidates from such pools due to, for example, lack of qualifications, incompatible location, experience, or education, it is also a common occurrence that hiring managers and suppliers are overwhelmed with data and thus cannot carefully isolate the most appropriate candidates for a position. Further, the speed at which technology-savvy staffing suppliers move from candidate identification to filling a job opening increases every day. Correspondingly, for most employers it is critical to rapidly identify suitable candidates for a given position given increased cost-pressures in the modern era.

One key to the successful utilization of candidate, supplier and hiring company data is to recognize the wide variety of information that is now made available. Achieving new methods of analyzing said data, automating access to said data, and the like, may facilitate the matching of candidates with job openings.

For the foregoing reasons there is a need for the virtual assistant disclosed in the present application, which is uniquely designed to interact with hiring managers, suppliers, and other users to collect the necessary data points algorithmically, process the data points using machine learning against user-specific configurations and client-specific databases to provide real time access to company, candidate, and supplier information in a mobile and web-based format.

### SUMMARY OF THE DISCLOSURE

To minimize the limitations found in the existing systems and methods, and to minimize other limitations that will be apparent upon the reading of this specification, the preferred embodiment of the present invention provides methods and systems of providing a virtually assisted staffing platform.

The present invention is directed to systems and methods of providing data-driven, client-specific, and embedded intelligence to a user in real time. This invention addresses several problems that persists in the field: that hiring managers, suppliers, hiring managers and other hiring entities are often overwhelmed with information. Further, the speed at which technology-savvy suppliers are able staffing requests, and schedule interviews is increasing every day.

Each of these issues may be facilitated by the present mobile and web-based virtually assisted staffing platform which leverages machine learning and interactive functionalities to allow suppliers to perform multiple actions. Such methods and systems facilitate identification of alternate employer locations, extraneous skills, external suppliers, and candidate identification.

In the preferred embodiment, the herein disclosed methods for providing a virtually assisted staffing platform comprise enrolling a staffing supplier, identifying external suppliers, matching users with information about external suppliers, identifying alternate employer locations, recommending alternate employer locations to users, and identifying extraneous skills of job applicants. Further the virtually assisted staffing platform comprises: receiving profiles from candidates, matching the profiles with the job requirements, recommending one or more candidates, providing an integrated interview scheduling feature, tracking activities of the candidates and the users, and providing updates to the candidates and the users based on the tracking information.

A first objective of the present invention is to provide a means to enhance job management efficiencies for users, staffing suppliers, hiring recruiters, hiring managers and other hiring entities.

A second objective of the present invention is to provide a means by which candidates can connect more efficiently with potential employers, through various media platforms.

A third objective of the present invention is to provide a means of focusing recruiter attention on securing interviews for candidates with the requisite skills required for a given job opportunity.

A fourth objective of the present invention is to provide a means for users, staffing suppliers and other job recruitment staff to identify alternative employer locations that may present cost-savings for a given user.

A fifth objective of the present invention is to provide a means for suppliers and other job recruitment staff to identify and eliminate extraneous skills for various job openings.

A sixth objective of the present invention is to provide a means for users and to determine whether to outsource recruiting efforts to external suppliers.

A seventh objective of the present invention is to provide a means for automated candidate recommendations, leveraging machine learning and mobile platforms.

These and other advantages and features of the present invention are described with specificity so as to make the present invention understandable to one of ordinary skill in the art. In addition, these and other features, aspects, and advantages of the present invention will become better understood with reference to the following description.

### BRIEF DESCRIPTION OF THE DRAWINGS

Elements in the figures have not necessarily been drawn to scale in order to enhance their clarity and improve understanding of these various elements and embodiments of the invention. Furthermore, elements that are known to be common and well understood to those in the industry are not depicted in order to provide a clear view of the various embodiments of the invention. Thus the drawings are generalized in form in the interest of clarity and conciseness.

FIG. 1A is a first screenshot from a desktop program showing the use of a virtual assistant to suggest alternative employer locations according to an embodiment of the invention;

FIG. 1B is a second screenshot from a desktop program showing the use of a virtual assistant to suggest alternative employer locations according to an embodiment of the invention;

FIG. 2 is a screenshot from a desktop program demonstrating the use of a virtual assistant to suggest removal or reclassification of extraneous skills for a job opening according to an embodiment of the invention;

FIG. 3 is a screenshot from a desktop program showing the use of a virtual assistant to identify and recommend candidates according to a preferred embodiment of the invention;

FIG. 4 screenshots from a mobile program showing the use of a virtual assistant to identify external suppliers. This figure exemplifies a lock screen notification according to a preferred embodiment of the invention;

FIGS. 5A and 5B show screenshots from a mobile program showing the use of a virtual assistant to identify successful suppliers a client has used in the past according to a preferred embodiment of the invention. This information may include data regarding the average length of time required to fill a particular role;

FIG. 6 shows a screenshot showing a distribution for a selected bill rate;

FIG. 7 shows an expense chart relating to employees and an analysis of the employees' expenses;

FIG. 8 shows an analysis and approval program for an employee's timecard; and

FIG. 9 shows a bill rate to tenure correlation graph.

### DETAILED DESCRIPTION

In the following discussion that addresses a number of embodiments and applications of the present invention, reference is made to the accompanying drawings that form a part hereof, and in which is shown by way of illustration specific embodiments in which the invention may be practiced. It is to be understood that other embodiments may be utilized and changes may be made without departing from the scope of the present invention.

Various inventive features are described below that can each be used independently of one another or in combination with other features. However, any single inventive feature may not address any of the problems discussed above or only address one of the problems discussed above. Further, one or more of the problems discussed above may not be fully addressed by any of the features described below.

As used herein, the singular forms “a”, “an” and “the” include plural referents unless the context clearly dictates otherwise. “And” as used herein is interchangeably used with “or” unless expressly stated otherwise. As used herein, the term “about” means +/−5% of the recited parameter. All embodiments of any aspect of the invention can be used in combination, unless the context clearly dictates otherwise.

Unless the context clearly requires otherwise, throughout the description and the claims, the words “comprise”, “comprising”, and the like are to be construed in an inclusive sense as opposed to an exclusive or exhaustive sense; that is to say, in the sense of “including, but not limited to”. Words using the singular or plural number also include the plural and singular number, respectively. Additionally, the words “herein,” “wherein”, “whereas”, “above,” and “below” and words of similar import, when used in this application, shall refer to this application as a whole and not to any particular portions of the application.

The description of embodiments of the disclosure is not intended to be exhaustive or to limit the disclosure to the precise form disclosed. While the specific embodiments of, and examples for, the disclosure are described herein for illustrative purposes, various equivalent modifications are possible within the scope of the disclosure, as those skilled in the relevant art will recognize.

The above-mentioned objectives are met by a computer-implemented method and system to provide a virtually assisted staffing platform providing automated job recruitment management. In some embodiments, a staffing platform is a network of computing devices that allows staffing suppliers and other users to exchange information about potential job candidates. The virtually assisted staffing platform of the present application is functional both as a web application (including websites, portals, plugins etc.) and as a mobile application, thereby permitting staffing suppliers and candidates to benefit from the application in a variety of settings.

The present invention, also referred to herein as a virtually assisted staffing platform, comprises a virtual assistant and a companion staffing platform. The virtually assisted staffing platform forms a component of a VMS (Virtual Managed Services) system. The present invention comprises two components: a virtual assistant and a staffing platform.

In the preferred embodiment, the virtual assistant comprises various functionalities including: matching profiles from candidates with job opportunity requirements, identifying successful staffing suppliers in a network (herein referred to as “external suppliers”), matching users with information about external suppliers, identifying alternate employer locations (i.e., cost-effective alternate hiring entity offices), identifying extraneous skills of candidates, and recommending candidates to users.

In the preferred embodiment, the staffing platform allows users to perform several functions including managing new staffing requests, managing interview scheduling, and managing expense approval in real-time. Users of the present invention generally include staffing suppliers and hiring entities. Staffing suppliers may include recruiters, staffing companies, freelance suppliers, lay users, and the like. Hiring entities are individuals who are themselves permanently employed by companies seeking to hire new employees. Hiring entities comprise hiring managers, administrators, managers, and the like.

As mentioned above, users may include staffing suppliers. Staffing suppliers work to fill job openings in businesses or organizations. The most common staffing supplier is a recruiter, who reviews candidate resumes, reviews candidate interview material, negotiates salaries, and ultimately places candidates in agreeable employment positions. There are various categories of recruiters. For instance, headhunters, executive recruiters, internal recruiters, Information Technology (IT) recruiters and so on. Regardless of recruiter category or classification, all recruiters search for qualified candidates and attempt to connect those candidates with suitable employment opportunities. Typically, in order to carry out this function, recruiters create a list of the most qualified job seekers and present the list to a hiring managers. Traditionally, hiring managers identify candidates using said recruiter lists and manage the recruitment process from the employer's perspective, including scheduling of interviews, management of expenses, submitting new staffing requests, and the like.

The present invention comprises a virtually assisted staffing platform that provides users a single web-based and mobile-based application that enables users to process job applications and various other job recruitment information simultaneously. The present virtually assisted staffing platform is compatible with a variety of operating systems including iOS, Android and other operating systems known in the art.

In the preferred embodiment, the herein disclosed methods for providing a virtually assisted staffing platform comprising: enrolling a staffing supplier, identifying external suppliers, matching users with information about external suppliers, identifying alternate employer locations, recommending alternate employer locations to users, identifying extraneous skills of job applicants, and the like. Further, the virtually assisted staffing platform comprises: receiving profiles from candidates, matching the profiles with job requirements, recommending one or more candidates, providing an integrated interview scheduling feature, tracking activities of the candidates and the users, and providing updates to the candidates and the users based on the tracking information.

### Virtual Assistant

In a preferred embodiment, the virtual assistant provides data-driven, client-specific, embedded intelligence to the user. In the preferred embodiment, the virtual assistant integrates with a staffing platform that is disclosed in greater detail below. When combined, these two software and/or hardware suites comprise the present invention, referred to herein as a virtually assisted staffing platform.

### Virtual Assistance Appearance & Function

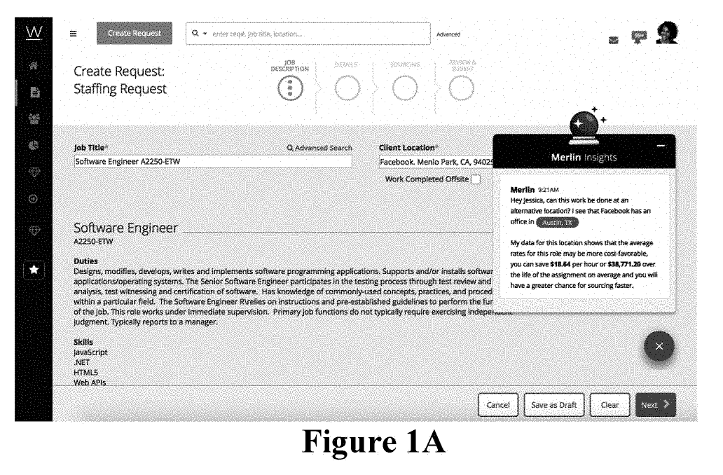

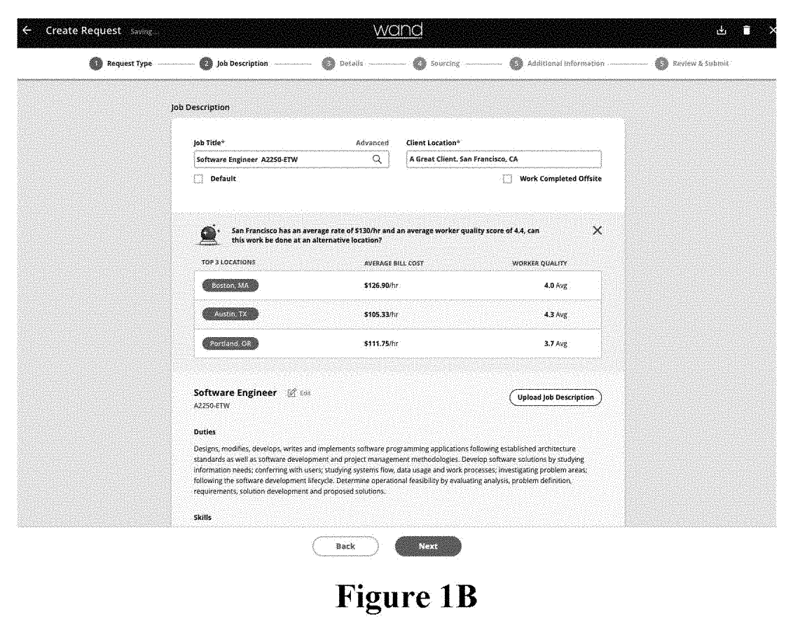

As shown in FIGS. 1A and 1B, the virtual assistant appears as a floating window and displays basic message information. Basic message information comprises the body of the message, automated data analysis integrated in the message, and a time-stamp relating to the message arrival time.

FIG. 1 shows an exemplary implementation of a virtual assistant for a computing device including a website-based application, and a visual representation of a virtual assistant. Although FIG. 1 shows animation icon (“Merlin Insights”) including a blue globe surrounded by several animated stars, the virtual assistant is not limited to such an appearance and may be represented as, for example, a cartoon head, an animal, an image captured from a video or still image, a graphical object, or as a voice only. The virtual assistance benefits from several social intelligence features. In particular, the virtual assistant uses natural language and provide effective, adaptive, and appropriate insights when interacting with the user. Creating the visual appearance, voice, and personality of a socially intelligent virtual assistant that is based on the personal and professional characteristics of the target user population may help the virtual assistant to be appealing to the target users.

The virtual assistant extracts information from the staffing platform (described below) and then generates one or more responses to interact with the user. In the preferred embodiment, the virtual assistant only appears when the assistant has actionable, insightful, recommendations to offer the user. As mentioned above, the virtual assistant appears on both mobile applications and the web interface. The underlying data is mined using machine learning, neural networks and analysts.

### Virtual Assistant Examples

Examples of data-driven, client-specific, embedded intelligence recommendations include but are not limited to the following four examples (I-IV):

### I. Alternate Employer Locations:

In some embodiments, when creating a job requisition, the virtual assistant may recommend alternate employer locations where resources are less expensive and/or readily available. Particularly, the machine learning module may compare information about the user, job requisition content, company locations, and wage context in order to make recommendations regarding alternate company locations. The machine learning module may make this comparison using decision logic stored on the computer, or by other standard methods well known in the art. Referring to FIG. 1, the virtual assistant recommends the alternate location of Austin, Tex. accompanied by the following message: “My data for this location shows that the average rates for this role may be more cost-favorable, you can save $18.64 per hour or $38,771.20 over the life of the assignment on average and you will have a greater chance for sourcing faster.” By comparing wage information in various states, the machine learning module of the present invention is able to determine the most cost-effective alternate employer location available.

### II. Identifying Extraneous Skills of Candidates:

In some embodiments, when creating a job requisition, the virtual assistant provides a skill change recommendation. Skill change recommendations comprise a suggested skill removal, skill re-identification, and/or skill re-classification of a job requirement for a particular position. Particularly, the machine learning module may compare received information about the candidate, job requisition content, factors driving premiums in rates, and historical data context in order to make recommendations regarding removal of the skill requirement, re-classification of the skill, or the like. The machine learning module may make this comparison using decision logic stored on the computer, or by other standard methods known in the art.

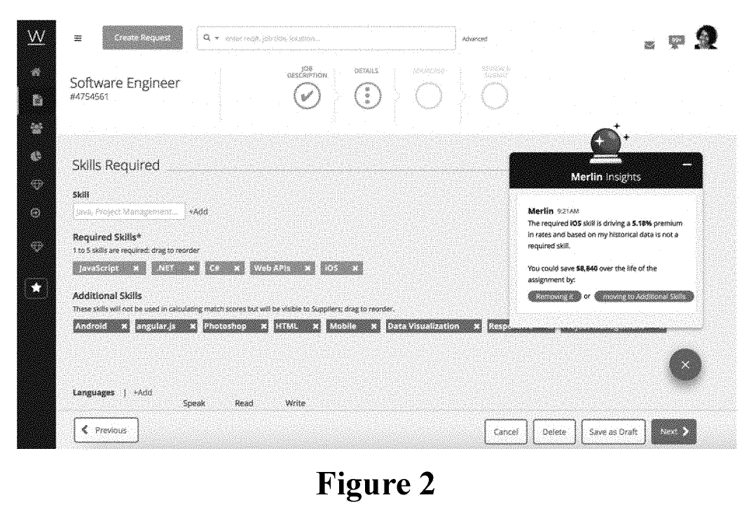

Referring to FIG. 2, for example, the virtual assistant lists current Required Skills and Additional skills for a given position. As shown in FIG. 2., the Software Engineer position requires 5 skills including JavaScript., .Net, C#, Web APIs and iOS. In this example, the virtual assistant recommends the removal of iOS as a required skill because, “a 5.18% premium in rates” exists and “based on my historical data (iOS) is not a required skill”. Further, the virtual assistant states, “You could save $8,840 over the life of the assignment by removing it or moving it to Additional Skills”. Thus, by comparing the historical data information with current premiums, the machine learning module is able to recommend removal of a particular skill, resulting in a more most cost-effective approach for the user.

### III. Identify & Recommend Candidates:

In some embodiments, when choosing suppliers during the requisition creation process, the virtual assistant may identify and recommend candidates from a internal and/or external database of candidates. Candidate recommendations are based primarily on an analysis of candidate information (See section V. for details regarding candidate information). Particularly, the machine learning module may compare received information about the candidate, job requisition content, Talent Network information, candidate hard skill and soft skill information, and other contextual information in order to make automated candidate recommendations. Candidate information may include, for example, how closely a candidate's background matches the job requirements compared to the average candidate using alternate external resources. The machine learning module may make this comparison using decision logic stored on the computer, or by other standard methods well known in the art.

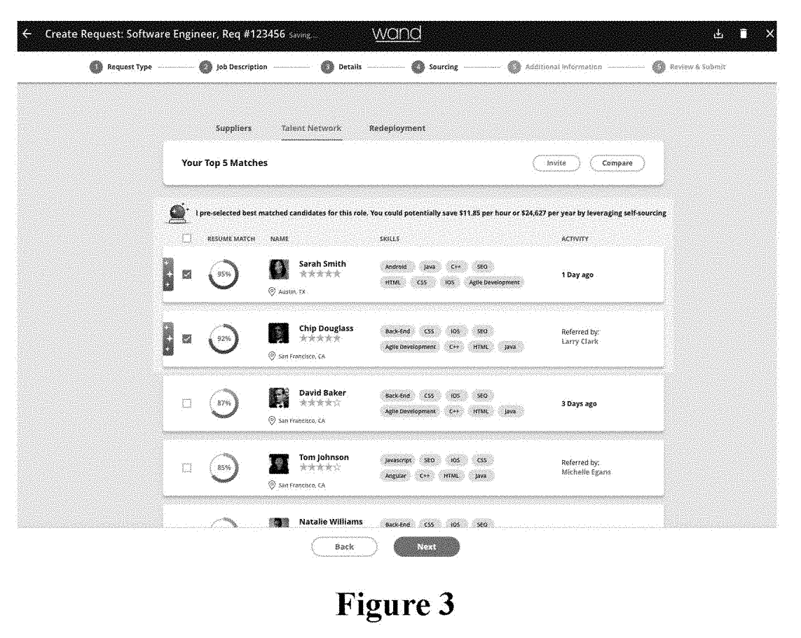

Referring to FIG. 3, for example, the virtual assistant appears on a web interface and states, “If you want to source it yourself and save on average $11.84 per hour, or $24,627 over the life of the assignment, I found 2 top candidates from Talent Network with the skills match.” Thus, by comparing internal Talent Network information with external resource information, the machine learning module is able to predict a cost-saving measure by sourcing the position internally.

### IV. Identifying External Suppliers:

In some embodiments, when creating a job requisition, the virtual assistant may recommend connecting with external suppliers who have been successful in filling similar roles in the past. Particularly, the machine learning module may compare received information about the candidate, job requisition content, number of days with no submissions, and the social network connections of a user in order to make recommendations regarding external suppliers. In this way, the virtual assistant identifies external suppliers and matches users with information about external suppliers The machine learning module may make this comparison using decision logic stored on the computer, or by other standard methods well known in the art.

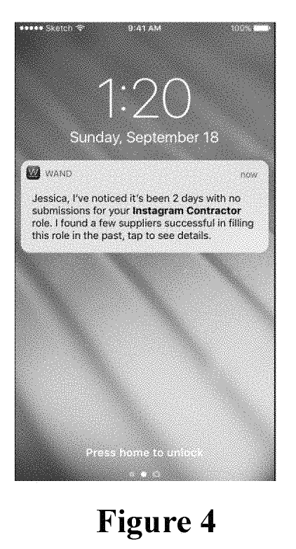

Referring to FIG. 4, the virtual assistant appears on a user mobile phone lock screen, enabling viewing of external supplier information without opening the application itself. As shown in FIG. 4, the virtual assistant recommends that that Jessica, a user of the platform, reach out to a “few suppliers successful in filling this role in the past”. Rather than recommending a social connection, the virtual assistant in this context provides an automated analysis suggesting how a supplier has achieved success in filling a particular job opening. In any case, the virtual assistant also provides a clickable means for users to rapidly outsource a particular task to external suppliers if so desired.

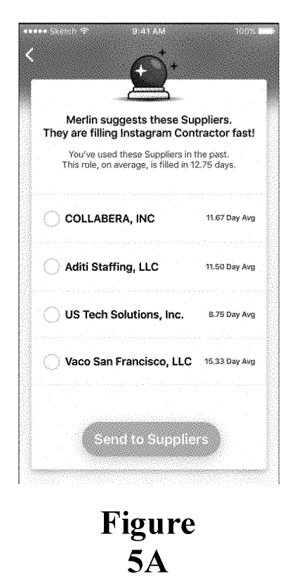

Referring to FIGS. 5A and 5B, the virtual assistant offers the user various useful pieces of information regarding potential external suppliers. For example, the virtual assistant point out which suppliers the user has utilized in the past. In another example, the virtual assistant provides hard data regarding the average length of time a particular position has remained open for external suppliers. Thus, by comparing external supplier success rates, durational context, social network information, and the like, the machine learning module of the present virtual assistant is able to determine whether outsourcing or insourcing a particular recruitment effort constitutes the most cost-effective path for a given user.

### V. Candidate Information

The range of candidate information contemplated by the present application is very broad. In some embodiments, candidate information comprises hard skills, soft skills, extraneous skills, salary expectations, hourly billable rates, geographic preferences, supplier engagement history, personal references, dates of availability, and a wide variety of other information related to past interviews and employment history.

In some embodiments, hard skill information relates to skills that are absolutely required for a given position. Hard skill information may derive from historical relationships such as prior employers, schools attended, subject matter area(s) of study, previous job titles, managerial qualifications, and other information commonly mined in resume databases.

In some embodiments, hard skill candidate information may comprise job titles for each of one or more jobs previously held by the candidate, length of time the candidate held each of one or more previous jobs, subject matter of each of one or more qualifications obtained by the candidate, job title of the most recent job held by candidate, whether the candidate has previously held a comparable management position, highest educational level attained by the candidate, and the number of commonly misspelled words in the candidate's resume. Other features, drawn from external data, may include but are not limited to: ranking of school attended, criminal record, periodical information, and the like.

In other embodiments, soft skill information relates to factors such as personality, cognitive ability, and/or social skills. In still other embodiments, extraneous skills may comprise any information not directly required of a job applicant. In other words, an extraneous skill could constitute a hard skill if an employer indicated that a particular skill was required. Thus, the description above listing sources of hard skill information is also applicable to the extraneous skill category.

### Staffing Platform

As described above, the present virtually assisted staffing platform comprises two interrelated components, the virtual assistant and the staffing platform. The staffing platform comprises an application providing users with automated job recruitment tools that integrate seamlessly with the virtual assistant described above. Below, the staffing platform of the present invention is disclosed in detail.

The staffing platform of the present invention provides users with a web-based and mobile-based application that enables users to process job applications and various other job recruitment information simultaneously. The staffing platform is compatible with a variety of operating systems including iOS, Android and other operating systems known in the art.

In the preferred embodiment, the staffing platform enables enrollment of users, enrollment of candidates, receiving new staffing requests from users via a new staffing request page, creating job requirements for users based on the information provided in the new staffing requests, receiving profiles from candidates, and finally matching the profiles with the job requirements. In some embodiments, the method for providing a staffing platform also includes providing an integrated interview scheduling feature, thereby allowing the candidates and the users to arrange interview times and/or locations. Interviewees are provided with potential interview time slots, and select their preferred time and location for the interview via the staffing platform.

In some embodiments, the staffing platform provides an integrated calling and chatting feature, allowing the candidates and the users to connect. In other embodiments, the staffing platform provides an expense management feature based on candidate and staffing supplier expenses. Hiring entities and/or staffing suppliers utilize the staffing platform to approve of or deny said expenses. In yet another embodiment, the staffing platform tracks various candidate activities and user activities, providing updates to the candidates and the users, based on said tracking. Candidate activities may include changes to prior employer history, phone call logs, email logs, etc. User activities may include the frequency of external supplier use, the number of virtual assistant recommendations accepted by a user, the number of virtual assistant alternative employer location recommendations accepted by a user, and the number of extraneous skill recommendations accepted by a user.

Notably, as in the case of the virtual assistant embodiments described above, the staffing sourcing component of the virtually assisted staffing platform also contemplates a web-based application for staffing suppliers. Further, in the preferred embodiment, the staffing platform is capable of providing real-time notifications to users regarding job management information without the need to log in to the application itself. In other words, notifications are visible from a user's mobile “lock screen” without the need for a user to unlock his or her phone. Job management information shown on the lock screen may comprise new staffing requests, interview scheduling, expense management, external supplier information, external supplier use, virtual assistant recommendations, alternative employer location recommendations, extraneous skill recommendations, and the like.

As mentioned above, as an initial step, users must engage in account enrollment on a user account enrollment page in order to utilize the staffing platform system aspect of the present invention. In some embodiments, account enrollment for users may include the following: user identification information is inputted, user contact information is inputted, a unique Email ID is generated, a password is created, and the like. In some embodiments, the Email ID may be used for tracking the users and for other contextual aspects of the staffing platform system. In some embodiments, staffing suppliers may post jobs on a variety of external staffing platforms with this unique Email ID.

In addition, candidates must engage in account enrollment on a candidate account enrollment page in order to utilize the staffing platform system. In some embodiments, account enrollment for candidates may include the following steps: candidate identification information is inputted, a unique Email ID is generated, a password is created, and the like.

Regarding the new staffing request functionality of the staffing system aspect of the present invention, the staffing platform is capable of providing new staffing requests from users via a new staffing request page. The new staffing requests are transmitted and processed in real-time on both mobile and web-based devices. In some embodiments, the new staffing request page provides users with job requisition information. Job requisition information may include absolute requirements for a given position including, for example, a required number of years of managerial experience, educational degrees, professional licenses, and the like.

The new staffing request page may further comprise candidate profiles, hiring entity names, duration of the requested contract, hourly billable rates, the number of open positions, position titles, position locations, alternate potential employer locations, number of action items requiring the user's attention, selectable search icons, selectable search filter icons, selectable email icons, links to more details, and the like. The requisition details accessible from said screen may be forwarded via email and other messaging services common in the art. As described above, the staffing platform aspect of the present virtually assisted staffing platform invention comprises both a job requisition review feature and job requisition forwarding feature. The later feature allows users to forward job requisition details to other users in a secure manner. In further reference to the new staffing request functionality of the present invention, in other embodiments the ability to view and communicate with previously submitted candidates is available. In yet another embodiment of the new staffing request functionality, the ability to view pending and completed interviews is available.

Regarding the integrated interview scheduling feature of the staffing platform, the staffing platform is capable of providing real-time information regarding interview scheduling on a mobile or web-based device. In the preferred embodiment, the integrated interview scheduling feature allows users to send up to five potential interview time slots to candidates. In other embodiments, the integrated interview scheduling feature allows users to choose their own time slots for an interview in real-time. In addition, the integrated interview scheduling feature allows candidates to email, text, or SMS chat with staffing suppliers regarding the interview times and locations. In some embodiments, the interview scheduling feature allows candidates to choose their preferred interview times or locations via the staffing platform.

Further to the interview scheduling feature, once an interview time slot is chosen by a given candidate the user then receives the candidates preferred times and/or locations via an interview notification module. The interview notification module alerts users to the chosen interview time and date via text message, SMS chat, email, or via a interviewing scheduling page. In some embodiments, this interview notification information is shared with all three parties via a shared calendaring system. In some embodiments of the staffing platform, the integrated interview scheduling feature also includes a follow-up tool wherein candidates and users are able to arrange for a follow-up recruiter meeting time and location, if needed.

In some embodiments, interview scheduling functionality of the staffing platform may permit display of the number of potential interview times provided to a candidate, the interview category (comprising phone interviews, and/or in-person interviews, and/or group lunches, and the like), the number of open related positions, in addition to the name of the hiring entity. Further, the staffing platform may display the position title for the open position, the allocated budget, the interview time, the interview location, alternate position locations, the number of action items requiring the user's attention, selectable search icons, selectable search filter icons, selectable email icons, links to more details, and the like. In some embodiments, the application is capable of displaying real-time notifications regarding interview times and the like without the need to log in to the application.

Regarding the expense management feature of the present invention, the staffing platform displays real-time notifications regarding candidate and staffing supplier expenses on both mobile and web-based devices. The expense management feature comprises information regarding the expense category, the name of spender, payments executed, reference numbers, and the hiring entity or other entity responsible for covering the expenses. The expense category includes candidate expense information related to food and/or hotel and/or gas and/or flight and/or uncategorized expenses, and the like. In some embodiments, users can view receipts, and exchange copies of the receipts with interviewees during follow-up recruiter meetings, if necessary. In some embodiments, the application is capable of displaying real-time notifications on a user's mobile lock screen such as new expenses logged without the need to log in to the application.

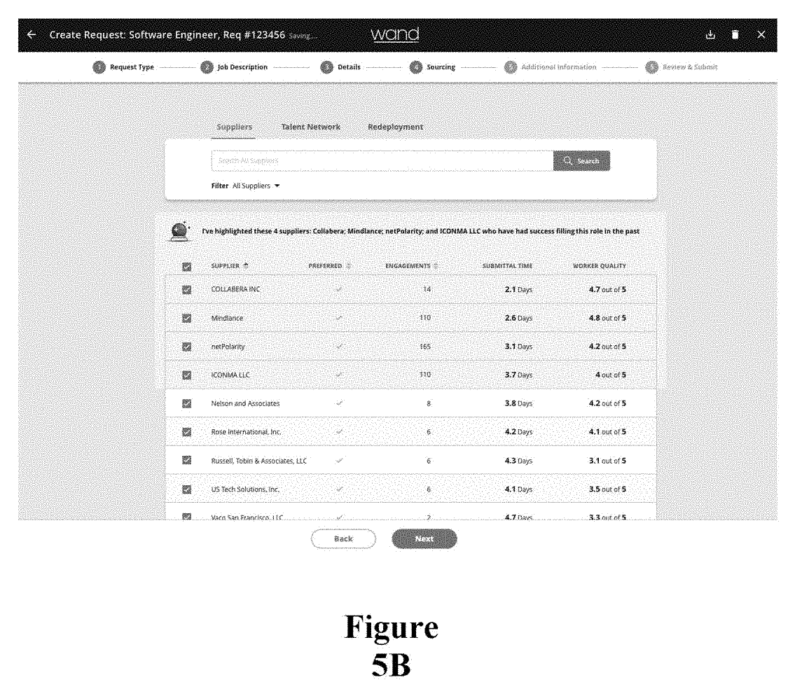

In still further embodiments, the system may provide insight into a candidate pool such as is shown in the distribution graph in FIG. 6. In this image, a position, location and rate is contrasted with the candidate pool for workers meeting the criteria and having a 4.0 or higher rating. A cost savings analysis shows that a supplier sourced candidate is likely to cost $105/Hour whereas a self sourced candidate $100/Hour, for a savings of $8640.00.

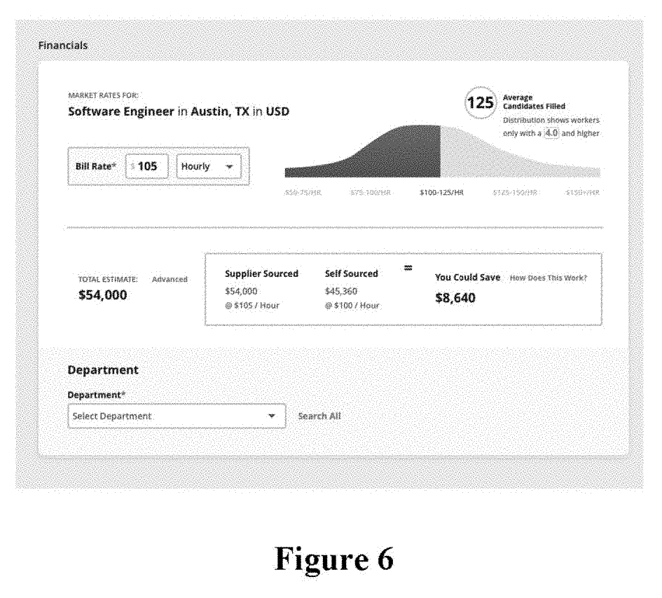

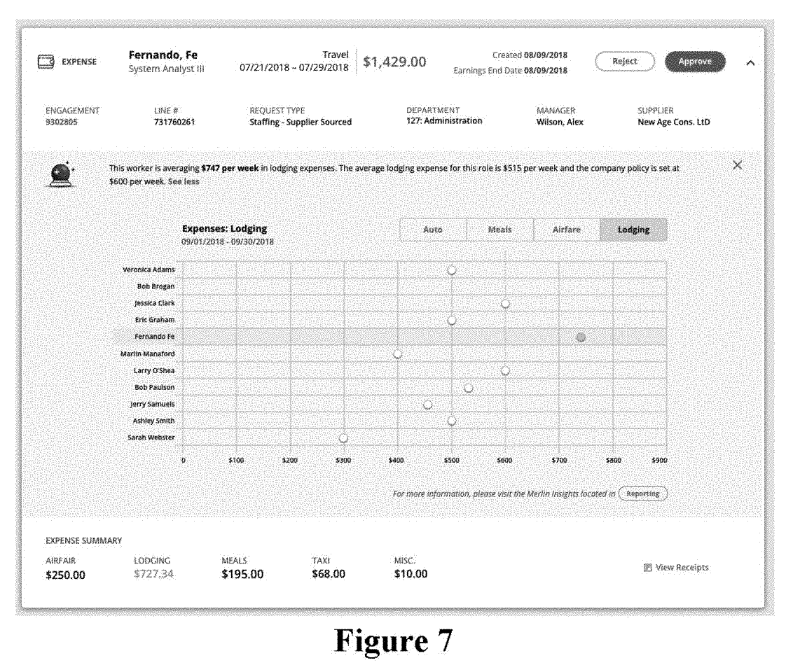

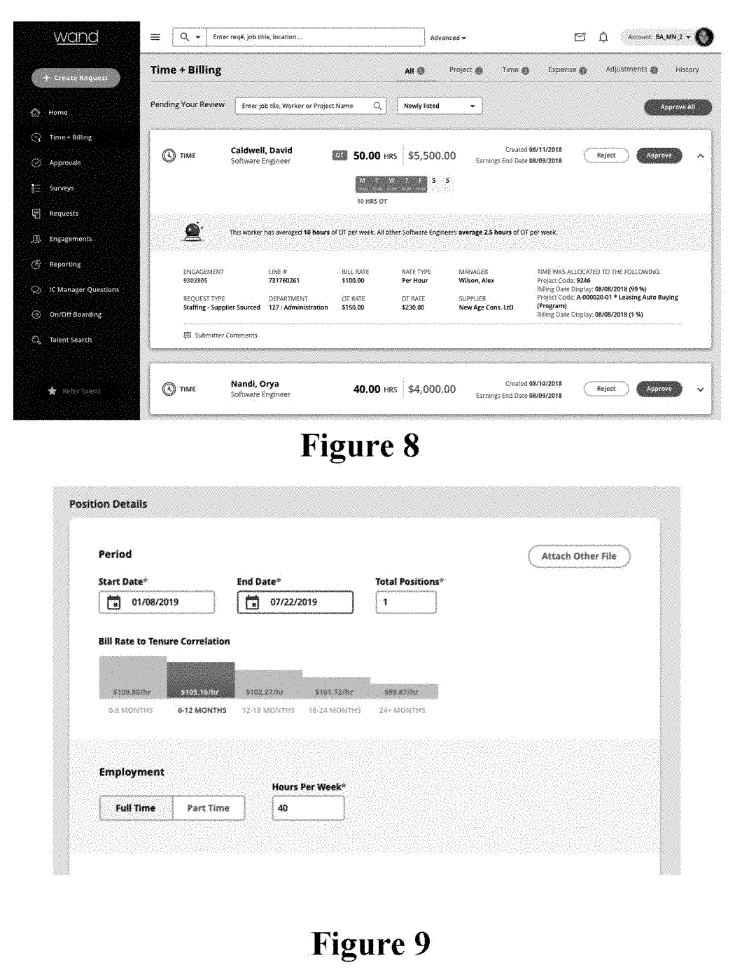

FIG. 7 shows additional potential cost savings information in that it shows a number of workers and their expenses compared with one another. The slide also provides the average in lodging expenses and the company policy. FIG. 8 shows various details with respect to time card approval, wherein information such as the bill rate, overtime rate, and other information is provided alongside an approve/reject option. FIG. 9 shows bill rate to tenure correlation information that may be provided to the assistance of the employer.

As noted above, the present invention contemplates a calling and chatting feature relevant to all of the job recruitment features herein described, including new staffing requests, integrated interview scheduling, and expense management. In the preferred embodiment, the staffing system integrates SMS, email, and texting buttons into each display page, allowing the candidates and the users to connect instantly.

Regarding the supplier search and filter functionalities of the present invention, the staffing platform provides real-time data-driven tools for users to filter their action items. In some embodiments, the supplier and search filter functionalities permit users to select from a variety of functions including, but not limited to: select all, requests, interviews, and/or expenses. Further, in some embodiments, suppliers can search the application by name, requisition number, engagement number, and/or other filters commonly used in the art.

As described above, in some embodiments the present invention comprises an information processing system and/or staffing sourcing system in a job recruitment environment. In one embodiment, the herein disclosed methods for providing a virtually assisted staffing platform comprise: enrolling a user and/or staffing supplier and/or hiring entity, identifying external suppliers, matching users with information about external suppliers, identifying alternate employer locations, recommending alternate employer locations to users, and identifying extraneous skills of job applicants.

In further embodiments, the virtually assisted staffing platform comprises: a system comprising a server connected to a network, wherein the server receives requests from users via a network. This server may include a processor(s), a database for storing candidate information, and a memory operatively coupled to the processor. In some embodiments of the present invention, memory stores program instructions that when executed by the processor, causes the processor to receive new staffing requests from a user via the network. Logistical interview information is generated from the candidate database based on the new staffing request. Finally, the potential interview times and locations are transmitted to the user via the network.

Referring further to the staffing sourcing system described above, the candidate information database comprises a database of information comprising candidate availability, candidate hard skills, candidate soft skills, candidate billing rates, candidate geographical preferences, automated candidate recommendations, and the like. Logistical interview information comprises at least potential interview dates feasible for candidates, potential interview times feasible for candidates, geographical information, hotel preferences, and the like.

As described above, the present invention is an application capable of displaying real-time notifications to a mobile device and/or website. A mobile device may be a wireless mobile device or any type of portable computer device, including a cellular telephone, a Personal Digital Assistant (PDA), smartphone, etc. By way of example only, and not by way of limitation, smartphones contemplated by the present invention include Apple's iPhone series, Google's Droid and Nexus One series, Palm's Pre series, and RIM's Blackberry series of smartphones. In some embodiments, mobile devices comprise a camera, a processor, a graphical user interface (GUI), and a memory. In embodiments, the memory is operatively coupled to the processor and stores program instructions that when executed by the processor, causes the processor to receive an image from the camera. Said image may be displayed on the GUI. The GUI may also receive descriptive data for the image and store the descriptive data and image as a listing. Generally, said listing may be transmitted wirelessly to a host server. Further, the mobile device may comprise a display, a GPS module, a compass, a camera and various other input/output (I/O) components.

As described above, the present invention relates to information processing methods and systems comprising a virtually assisted staffing platform. Said system can take the form of an entirely hardware embodiment, an entirely software embodiment or an embodiment containing both hardware and software elements. In one embodiment, the system is implemented in software, which includes but is not limited to firmware, resident software, microcode, etc.

Furthermore, the system can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium comprise a semiconductor or solid-state memory, magnetic tape, a removable computer diskette, a random access memory (RAM), a read-only memory (ROM), a rigid magnetic disk and an optical disk. Current examples of optical disks comprise compact disk-read only memory (CD-ROM), compact disk-read/write (CD-R/W) and DVD.

A data processing system suitable for storing and/or executing program code comprises at least one processor coupled directly or indirectly to memory elements through a system bus. The memory elements can include local memory employed during actual execution of the program code, bulk storage, and cache memories that provide temporary storage of at least some program code in order to reduce the number of times code is retrieved from bulk storage during execution

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

Described above, aspects of the present application are embodied in a World Wide Web (“WWW”) or (“Web”) site accessible via the Internet. As is well known to those skilled in the art, the term “Internet” refers to the collection of networks and routers that use the Transmission Control Protocol/Internet Protocol (“TCP/IP”) to communicate with one another. The internet 20 can include a plurality of local area networks (“LANs”) and a wide area network (“WAN”) that are interconnected by routers. The routers are special purpose computers used to interface one LAN or WAN to another. Communication links within the LANs may be wireless, twisted wire pair, coaxial cable, or optical fiber, while communication links between networks may utilize 56 Kbps analog telephone lines, 1 Mbps digital T-1 lines, 45 Mbps T-3 lines or other communications links known to those skilled in the art.

Furthermore, computers and other related electronic devices can be remotely connected to either the LANs or the WAN via a digital communications device, modem and temporary telephone, or a wireless link. It will be appreciated that the internet comprises a vast number of such interconnected networks, computers, and routers.

The Internet has recently seen explosive growth by virtue of its ability to link computers located throughout the world. As the Internet has grown, so has the WWW. As is appreciated by those skilled in the art, the WWW is a vast collection of interconnected or “hypertext” documents written in HTML, or other markup languages, that are electronically stored at or dynamically generated by “WWW sites” or “Web sites” throughout the Internet. Additionally, client-side software programs that communicate over the Web using the TCP/IP protocol are part of the WWW, such as JAVA® applets, instant messaging, e-mail, browser plug-ins, Macromedia Flash, chat and others. Other interactive hypertext environments may include proprietary environments such as those provided in America Online or other online service providers, as well as the “wireless Web” provided by various wireless networking providers, especially those in the cellular phone industry. It will be appreciated that the present application could apply in any such interactive communication environments, however, for purposes of discussion, the Web is used as an exemplary interactive hypertext environment with regard to the present application.

A website is a server/computer connected to the Internet that has massive storage capabilities for storing hypertext documents and that runs administrative software for handling requests for those stored hypertext documents as well as dynamically generating hypertext documents. Embedded within a hypertext document are a number of hyperlinks, i.e., highlighted portions of text which link the document to another hypertext document possibly stored at a website elsewhere on the Internet. Each hyperlink is assigned a URL that provides the name of the linked document on a server connected to the Internet. Thus, whenever a hypertext document is retrieved from any web server, the document is considered retrieved from the World Wide Web. Known to those skilled in the art, a web server may also include facilities for storing and transmitting application programs, such as application programs written in the JAVA® programming language from Sun Microsystems, for execution on a remote computer. Likewise, a web server may also include facilities for executing scripts and other application programs on the web server itself.

A remote access user may retrieve hypertext documents from the World Wide Web via a web browser program. A web browser, such as Netscape's NAVIGATOR® or Microsoft's Internet Explorer, is a software application program for providing a user interface to the WWW. Upon request from the remote access user via the web browser, the web browser requests the desired hypertext document from the appropriate web server using the URL for the document and the hypertext transport protocol (“HTTP”). HTTP is a higher-level protocol than TCP/IP and is designed specifically for the requirements of the WWW. HTTP runs on top of TCP/IP to transfer hypertext documents and user-supplied form data between server and client computers. The WWW browser may also retrieve programs from the web server, such as JAVA applets, for execution on the client computer. Finally, the WWW browser may include optional software components, called plugins, that run specialized functionality within the browser.

The foregoing description of the preferred embodiment of the present invention has been presented for the purpose of illustration and description. It is not intended to be exhaustive or to limit the invention to the precise form disclosed. Many modifications and variations are possible in light of the above teachings. It is intended that the scope of the present invention not be limited by this detailed description, but by the claims and the equivalents to the claims appended hereto.

What is claimed is:

1. A method for providing a virtually assisted staffing platform for automated job management, the method comprising:
a. receiving new staffing requests from users;
b. providing a virtual assistant displaying basic message information;
c. identifying alternate employer locations;
d. providing alternate employer location information;
e. identifying extraneous skills;
f. identifying external supplier information;
g. matching users with information about external suppliers;
h. receiving new staffing requests from users;
i. receiving profiles from candidates;
j. matching the profiles with the job requirements;
k. recommending one or more candidates to the users.

2. The method of claim 1, wherein the basic message information further comprises automated data analysis.

3. The method of claim 1, wherein the user comprises a staffing supplier and/or a hiring entity.

4. The method as claimed in claim 3, wherein the staffing supplier comprises a recruiter.

5. The method as claimed in claim 3, wherein the hiring entity comprises a hiring manager and/or administrator.

6. The method of claim 1, wherein the virtual assistant leverages machine learning and/or data-driven and/or embedded intelligence.

7. The method of claim 1, wherein alternate employer location information derives from a comparison of wage information in various states.

8. The method of claim 1, wherein identifying extraneous skills comprises skill change recommendations.

9. The method of claim 10, wherein skill change recommendations comprise suggested skill removal, skill re-identification, and/or skill re-classification of job requirement(s).

10. A method for providing a virtually assisted staffing platform for automated job management, the method comprising:
a. providing a virtual assistant displaying basic message information, wherein basic message information comprises automated data analysis;
b. identifying alternate employer locations;
c. providing alternate employer location information;
d. identifying extraneous skills;
e. receiving new staffing requests from a user, wherein a user comprises a staffing supplier and/or a hiring entity;
f. receiving new staffing requests from users;
g. receiving profiles from candidates;
h. matching the profiles with the job requirements;
i. identifying candidates;
j. recommending one or more candidates to the users, wherein recommendations are based on an analysis of candidate information;
k. tracking activities of the candidates and the users; and
l. providing updates to the candidates and the users, based on the tracking.

11. The method of claim 10, wherein candidate information comprises an analysis of hard skill information.

12. The method of claim 11, wherein hard skill information derives from historical relationships.

13. The method of claim 10, wherein candidate information comprises soft skill information.

14. The method of claim 10, wherein the virtually assisted staffing platform further comprises identifying external supplier information.

15. The method of claim 14, wherein identifying external supplier information further comprises matching users with information about external suppliers.

16. The method of claim 10, wherein the virtually assisted staffing platform further comprises an integrated interview scheduling feature.

17. The method of claim 10, wherein alternate employer location information further comprises providing an integrated interview scheduling feature in the staffing platform.

18. The method of claim 10, further comprising providing an integrated calling and chatting feature in the staffing platform thereby allowing the candidates and the users to connect instantly.

19. The method of claim 10, wherein the new staffing requests further comprise information regarding hourly billable rates.

20. A virtually assisted staffing platform comprising:
a. a server connected to a network, the server receiving requests from users via the network, the server comprising:
i. at least one processor coupled directly or indirectly to memory elements;
ii. a database for storing trigger image information; and
iii. a memory operatively coupled to the processor, the memory storing program instructions that when executed by the processor, causes the processor to:
1. receive new staffing request from a user via the network;
2. determine logistical interview information generated from the candidate database based on the new staffing request; and
3. send potential interview times and locations to the user via the network.
